(19) United States
(12) Patent Application Publication
(10) Pub. No.: US 2026/0169649 A1
(43) Pub. Date: Jun. 18, 2026

(54) SYSTEMS, METHODS, AND STORAGE MEDIA FOR EMERGENCY HANDLING OF URBAN STORAGE TANKS BASED ON IOT LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/536,156

(22) Filed: Feb. 10, 2026

(30) Foreign Application Priority Data
Jan. 19, 2026 (CN) 202610063800.0

(51) Int. Cl. G06F 3/06; B25J 9/16; G05B 15/02; G06N 20/00; G07C 5/00

(52) U.S. Cl. CPC G06F 3/0653; B25J 9/1697; G05B 15/02; G06N 20/00; G07C 5/008

(57) ABSTRACT

Provided is a system for emergency handling of urban storage tanks based on an IoT large model. The system includes an emergency supervision management platform. The emergency supervision management platform is configured to: obtain a tank working state of a storage tank at a first preset time; determine a state change value of the storage tank based on the tank working state; in response to determining that the state change value satisfies a first preset condition, determine an emergency control parameter based on tank monitoring data, wherein the emergency control parameter includes a water mist spraying speed of a cooling device; and control the cooling device to spray water mist toward an outer wall of the storage tank based on the emergency control parameter.

### CROSS-REFERENCE TO RELATED APPLICATIONS

This application claims priority of Chinese Patent Application No. 202610063800.0, filed on Jan. 19, 2026, the entire contents of which are incorporated herein by reference.

### TECHNICAL FIELD

The present disclosure generally relates to a field of emergency handling of urban storage tanks, and in particular, to a system, a method, and a storage medium for emergency handling of urban storage tanks based on an Internet of Things (IoT) large model.

### BACKGROUND

With the rapid development of smart cities and industry, the count of urban storage tanks (e.g., gas storage tanks, oil storage tanks, etc.) is also increasing. Storage tanks are prone to leakage or even combustion and explosion when operating frequently and in harsh environments such as high temperatures, which may not only cause huge economic losses but also pose a serious threat to urban safety, the ecological environment, and the health of the residents.

Traditional systems for monitoring and emergency handling of storage tanks usually rely on manual inspections or a single type of sensor network to detect anomalies, and only perform post-event handling after abnormalities occur in the storage tanks. Such systems lack intelligent proactive pre-perception and handling capabilities, making it difficult to meet the real-time and intelligent requirements for storage tank emergency handling in modern smart cities.

Therefore, it is necessary to provide a system, a method, and a storage medium for emergency handling of urban storage tanks based on an IoT large model, which can accurately and effectively improve the response speed and accuracy to emergency events of storage tanks.

### SUMMARY

One or more embodiments of the present disclosure provide a system for emergency handling of urban storage tanks based on an Internet of Things (IoT) large model. The system includes an emergency supervision management platform. The emergency supervision management platform is configured to: obtain a tank working state of a storage tank at a first preset time; determine a state change value of the storage tank based on the tank working state; in response to determining that the state change value satisfies a first preset condition, determine an emergency control parameter based on tank monitoring data, wherein the emergency control parameter includes a water mist spraying speed of a cooling device; and control the cooling device to spray water mist toward an outer wall of the storage tank based on the emergency control parameter.

One or more embodiments of the present disclosure provide a method for emergency handling of urban storage tanks based on an IoT large model. The method includes: obtaining a tank working state of a storage tank at a first preset time; determine a state change value of the storage tank based on the tank working state; in response to determining that the state change value satisfies a first preset condition, determining an emergency control parameter based on tank monitoring data, wherein the emergency control parameter includes a water mist spraying speed of a cooling device; and controlling the cooling device to spray water mist toward an outer wall of the storage tank based on the emergency control parameter.

One or more embodiments of the present disclosure provide a non-transitory computer-readable storage medium. The storage medium stores computer instructions. When a computer reads the computer instructions in the storage medium, the computer executes the method for emergency handling of the urban storage tanks based on the IoT large model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram illustrating a platform structure of a system for emergency handling of urban storage tanks based on an IoT large model according to some embodiments of the present disclosure;

FIG. 2 is a flowchart illustrating an exemplary process for emergency handling of urban storage tanks based on an IoT large model according to some embodiments of the present disclosure;

FIG. 3 is a flowchart illustrating an exemplary process for a patrol robot to complete a patrol according to some embodiments of the present disclosure;

FIG. 4 is a schematic diagram of a patrol parameter model according to some embodiments of the present disclosure; and

FIG. 5 is a schematic diagram illustrating an exemplary process for updating a pump pressure according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they can achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

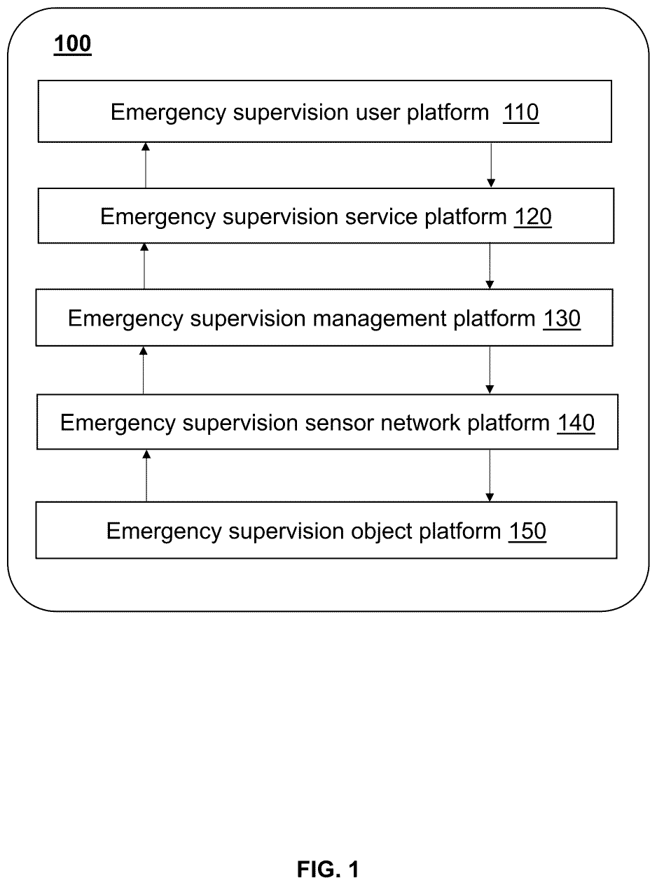

FIG. 1 is a diagram illustrating a platform structure of a system for emergency handling of urban storage tanks based on an IoT large model according to some embodiments of the present disclosure.

In some embodiments, a system 100 for emergency handling of urban storage tanks based on an IoT large model may include an emergency supervision user platform 110, an emergency supervision service platform 120, an emergency supervision management platform 130, an emergency supervision sensor network platform 140, and an emergency supervision object platform 150.

The emergency supervision user platform 110 refers to a platform for interacting with a user. In some embodiments, the emergency supervision user platform 110 is configured as a terminal device, e.g., a mobile phone, a computer, and applications, webpages, etc., installed thereon.

In some embodiments, the emergency supervision user platform 110 exchanges information with the emergency supervision service platform 120.

The emergency supervision service platform 120 refers to an interactive service platform for receiving and transmitting data.

In some embodiments, the emergency supervision service platform 120 may perform information interaction with the emergency supervision user platform 110 and the emergency supervision management platform 130. For example, the emergency supervision service platform 120 may obtain data such as a tank working state, tank monitoring data, an emergency control parameter, etc., from the emergency supervision management platform 130 and send the data to the emergency supervision user platform 110. In some embodiments, the emergency supervision service platform 120 is configured as devices such as a server, a switch, etc.

The emergency supervision management platform 130 refers to a platform that coordinates and manages connections and collaborations among various functional platforms, aggregates all information of the Internet of Things (IoT), and provides perception management and control management functions for the IoT. In some embodiments, the emergency supervision management platform 130 includes a processor and a storage medium. In some embodiments, the storage medium includes a hard disk drive, a storage array, etc. The storage medium may be used to store data such as operation records and maintenance logs of the storage tank.

In some embodiments, the emergency supervision management platform 130 may perform information interaction with the emergency supervision service platform 120 and the emergency supervision sensor network platform 140, respectively. For example, the emergency supervision management platform 130 may send the tank monitoring data to the emergency supervision service platform 120. As another example, the emergency supervision management platform 130 may send an instruction for obtaining tank operation data to the emergency supervision sensor network platform 140 to obtain current tank operation data.

The emergency supervision sensor network platform 140 refers to a functional platform for managing sensor communication. In some embodiments, the emergency supervision sensor network platform 140 may implement functions of sensing communication of perception information and sensing communication of control information, e.g., implementing sensing communication of perception information of the tank operation data.

In some embodiments, the emergency supervision sensor network platform 140 includes communication devices such as a routing gateway.

The emergency supervision object platform 150 refers to a platform for collecting emergency supervision data and executing instructions.

In some embodiments, the emergency supervision object platform 150 includes a plurality of emergency supervision object sub-platforms. The emergency supervision object sub-platforms are configured as devices such as temperature sensors, humidity sensors, pressure sensors, etc. The plurality of emergency supervision object sub-platforms may be respectively configured at a cooling device, a patrol robot, a tank pipeline network, and a plurality of storage tanks.

A storage tank refers to a storage facility used for storing chemical substances in industrial production, e.g., an oil storage tank, a gas storage tank, etc. In some embodiments, a temperature sensor may be installed on the outer wall of the storage tank to detect a temperature of the storage tank. A flow meter, a pressure gauge, or other devices may also be installed at an inlet and an outlet of the storage tank to obtain data such as a liquid storage flow rate and the pump pressure. A detection device, such as an environmental hygrometer, a wind vane, and an anemometer, may also be installed near the storage tank to obtain environmental humidity and environmental wind data.

The cooling device refers to a device configured to reduce a temperature of the outer wall of the storage tank, e.g., an external spraying device, etc. The external spraying device may spray water mist onto the outer wall of the storage tank, and reduce the temperature of the storage tank through heat absorption via water mist evaporation.

In some embodiments, the cooling device may obtain an emergency control parameter for water mist spraying from the emergency supervision management platform 130.

The patrol robot is configured to perform real-time monitoring, safety inspection, and abnormal warning for an area where the storage tank is located. In some embodiments, the patrol robot is equipped with a data collection device (e.g., a camera, a temperature sensor, a humidity sensor, a pressure sensor, etc.).

In some embodiments, the patrol robot may obtain a patrol parameter for patrolling from the emergency supervision management platform 130, and send tank monitoring data collected by the patrol robot to the emergency supervision management platform 130.

In some embodiments, the patrol robot includes a light detection and ranging (LiDAR) and an ultrasonic obstacle avoidance device. The patrol robot may perceive an obstacle in real time and automatically adjust a patrol path through the LiDAR and the ultrasonic obstacle avoidance device.

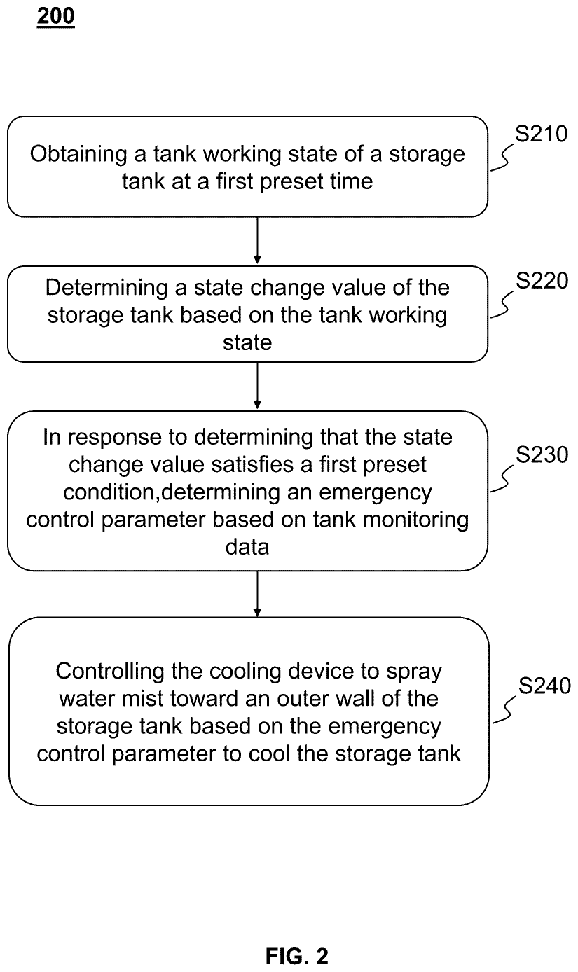

More description of the above platforms, sensors, and devices may be found in FIGS. 2-5 and related descriptions thereof.

In some embodiments of the present disclosure, the system for emergency handling of the urban storage tanks based on the IoT large model may perform data and information exchange between various functional platforms, form an information operation closed loop, and operate in a coordinated and regular manner under unified management, thereby achieving efficient and accurate processing of emergency handling data of the storage tank and improving safety of the storage tank. By replacing manual safety inspection of the area where the storage tank is located with the patrol robot and simultaneously performing real-time data collection, inspection efficiency and accuracy of safety warning may be improved, and a safety risk of the storage tank may be reduced.

It should be noted that the above description of the system for emergency handling of the urban storage tanks based on the IoT large model is merely for convenience of description and may not limit the present disclosure to the scope of the embodiments described. It may be understood that for those skilled in the art, after understanding the principle of the system, various modules may be arbitrarily combined, or a subsystem may be formed and connected to other modules without departing from the principle. In some embodiments, the emergency supervision user platform 110, the emergency supervision service platform 120, the emergency supervision management platform 130, the emergency supervision sensor network platform 140, and the emergency supervision object platform 150 disclosed in FIG. 1 may be different platforms in one system, or one platform may implement functions of two or more of the above platforms. For example, the platforms may share one storage module, or each module may have its own storage module. Such modifications are within the protection scope of the present disclosure.

FIG. 2 is a flowchart illustrating an exemplary process for emergency handling of urban storage tanks based on an IoT large model according to some embodiments of the present disclosure. As shown in FIG. 2, a process 200 includes the following operations. In some embodiments, the process 200 may be executed by a processor.

S210, obtaining a tank working state of a storage tank at a first preset time.

The first preset time refers to a preset historical time period. In some embodiments, the first preset time may be set by technicians based on experience. For example, the first preset time may be one hour ago, one day ago, etc.

The tank working state may reflect a current operating condition of the storage tank. In some embodiments, the tank working state includes, but is not limited to, liquid storage input, liquid storage output, pressurization, maintenance, etc.

In some embodiments, the processor may obtain the tank working state in various ways. For example, the processor may determine whether the liquid storage flow rate and the pressure of the storage tank change based on the patrol robot, thereby determining whether the storage tank is currently in a state of liquid storage input, liquid storage output, pressurization, or the like. The processor may collect on-site images of the storage tank using the patrol robot, and determine that the working state of the storage tank is maintenance if maintenance personnel are detected through an image recognition algorithm. As another example, the processor may retrieve the operation record and a maintenance log of the storage tank from a storage medium, thereby determining the tank working state and storing the tank working state in the storage medium.

S220, determining a state change value of the storage tank based on the tank working state.

The state change value may indicate whether the working state of the storage tank has changed. In some embodiments, when the working state of the storage tank has changed within the first preset time, the state change value corresponding to the first preset time is 1; when the working state of the storage tank has not changed within the first preset time, the state change value corresponding to the first preset time is 0.

In some embodiments, the processor may obtain an initial tank working state at a start time of the first preset time, compare the tank working state at all time points within the first preset time with the initial tank working state, and if the tank working state at any time point is inconsistent with the initial tank working state, the state change value within the first preset time is 1; otherwise, the state change value within the first preset time is 0.

S230, in response to determining that the state change value satisfies a first preset condition, determining an emergency control parameter based on tank monitoring data.

The first preset condition is a judgment condition for determining whether emergency cooling of the storage tank is required.

In some embodiments, the first preset condition may be determined based on an actual application scenario and requirement. For example, the first preset condition may be: the state change value of the storage tank within the first preset time is 1.

The emergency control parameter is a parameter for controlling operation of a cooling device. In some embodiments, when the state change value satisfies the first preset condition, it indicates that the storage tank is prone to abnormality. The processor may determine the emergency control parameter to control the cooling device to perform cooling treatment on the storage tank, thereby ensuring safe operation of the storage tank. More descriptions of the cooling device may be found in FIG. 1 and related descriptions thereof.

In some embodiments, the emergency control parameter includes a water mist spraying speed of the cooling device, i.e., a water flow speed when the cooling device performs spray cooling on the storage tank.

In some embodiments, the emergency control parameter may further include other parameters, such as the water mist spraying direction. More descriptions of the water mist spraying direction may be found in later descriptions.

In some embodiments, the processor may determine the emergency control parameter based on the tank monitoring data.

The tank monitoring data may reflect a state feature of operation of the storage tank. In some embodiments, the tank monitoring data includes an outer wall temperature of the storage tank.

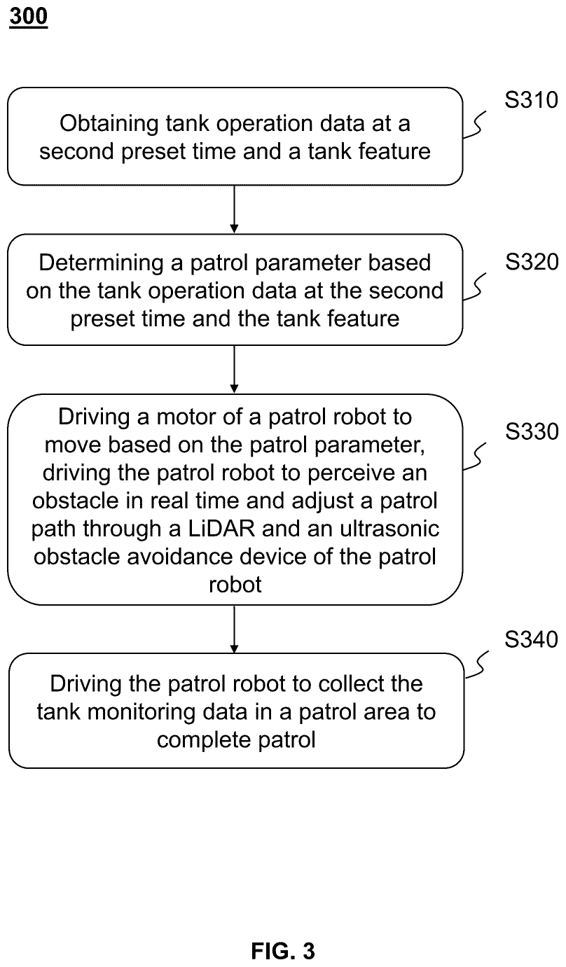

In some embodiments, the processor may collect the tank monitoring data in various ways. For example, the processor may collect the tank monitoring data through a temperature and humidity sensor on the storage tank, etc. As another example, the processor may collect the tank monitoring data through a patrol robot. More descriptions of collecting the tank monitoring data by the patrol robot may be found in FIG. 3 and related descriptions thereof.

In some embodiments, the water mist spraying speed may be related to the outer wall temperature of the storage tank. For example, the water mist spraying speed may be positively correlated with the outer wall temperature of the storage tank. The higher the outer wall temperature of the storage tank, the faster the water mist spraying speed, to rapidly lower the outer wall temperature of the storage tank. The lower the outer wall temperature of the storage tank, the slower the water mist spraying speed, to save water.

In some embodiments, the processor may further periodically determine the water mist spraying speed based on a temperature change rate and a humidity change rate.

In some embodiments, the emergency supervision management platform is further configured to: within a preset cycle: obtain tank operation data and environmental humidity of a previous cycle; determine the temperature change rate based on the tank operation data of the previous cycle, and determine the humidity change rate based on the environmental humidity of the previous cycle; and determine a water mist spraying speed of a current cycle based on the temperature change rate and the humidity change rate.

The preset cycle refers to an adjustment cycle of the water mist spraying speed. The previous cycle refers to a cycle immediately preceding the current preset cycle.

In some embodiments, a cycle duration of the preset cycle may be determined in various ways. For example, the cycle duration of the preset cycle may be determined according to an actual application scenario and requirements.

In some embodiments, the cycle duration of the preset cycle is related to the patrol parameter. For example, the cycle duration of the preset cycle is negatively correlated with a data collection time of the storage tank. The longer the data collection time of the storage tank, the shorter the cycle duration of the preset cycle.

More descriptions of the patrol parameter and the data collection time of the storage tank may be found in FIG. 3 and related descriptions thereof.

According to some embodiments of the present disclosure, the longer the data collection time of the storage tank, the more likely the tank operation data is not updated in a timely manner. Since the tank operation data may be obtained in real time through the IoT, when the data collection time of the storage tank is long, shortening the cycle duration of the preset cycle may increase a frequency of obtaining the tank operation data and the environmental humidity of the previous cycle, which may overcome the drawback of untimely updating the tank operation data, improve efficiency and accuracy of cooling control of the storage tank, and ensure safety of the storage tank.

The environmental humidity refers to humidity in an area where the storage tank is located.

In some embodiments, the processor may obtain the tank operation data of the previous cycle from the storage medium, and obtain the environmental humidity through an environmental hygrometer. More descriptions of the tank operation data may be found in the above descriptions. More descriptions of the environmental hygrometer may be found in FIG. 1 and related descriptions thereof.

The temperature change rate refers to a rate at which the outer wall temperature of the storage tank changes.

In some embodiments, the processor may obtain outer wall temperatures of the storage tank at a plurality of time points in the previous cycle from the tank monitoring data, construct a linear fitting function based on the plurality of time points and the outer wall temperatures of the storage tank corresponding to the plurality of time points respectively, and determine a slope of the linear fitting function as the temperature change rate.

The humidity change rate refers to a rate at which the environmental humidity in the area where the storage tank is located changes over time. A manner for determining the humidity change rate is similar to that for determining the temperature change rate. More descriptions of determining the humidity change rate may be found in the relevant description of determining the temperature change rate mentioned above.

In some embodiments, the processor may normalize the temperature change rate and the humidity change rate, respectively, and perform a weighted sum on the normalized temperature change rate and the normalized humidity change rate to obtain a change rate score.

Merely by way of example, the processor may obtain the change rate score based on the following formula (1):

$$P = {k}_{1} \times A + {k}_{2} \times B , \qquad ( 1 )$$

where P represents a change rate score, A represents a normalized temperature change rate, B represents a normalized humidity change rate, k₁ and k₂ are coefficients greater than 0, and values of the coefficients k₁ and k₂ may be preset based on prior experience.

In some embodiments, the water mist spraying speed is negatively correlated with the change rate score. A larger change rate score indicates faster cooling and humidification of the outer wall of the current storage tank, at which time the possibility of risk occurrence in the storage tank decreases, and the water mist spraying speed may be appropriately reduced to save water; conversely, a smaller change rate score indicates slower cooling and humidification of the outer wall of the current storage tank, and the outer wall temperature of the storage tank may be difficult to decrease, at which time an accident is likely to occur in the storage tank, and the water mist spraying speed needs to be increased.

In some embodiments, to ensure safety of the storage tank, the water mist spraying speed may not be lower than a lower limit of the water mist spraying speed, and the lower limit of the water mist spraying speed may be determined based on presets by relevant personnel, or adjusted according to actual on-site conditions.

In some embodiments, during water mist spraying, the processor detects abnormal conditions such as temperature rise or humidity drop on the outer wall of the storage tank, indicating that accidents such as internal combustion or chemical reactions may occur inside the storage tank, and the processor may activate an emergency plan to timely contain malignant accidents. The emergency plan may include broadcast warning, personnel evacuation, activation of firefighting facilities, etc. The emergency plan may be determined based on actual scenario requirements.

According to some embodiments of the present disclosure, since environmental humidity affects thermal conductivity, thereby affecting the temperature change rate, comprehensively considering the temperature change rate and the humidity change rate to determine the water mist spraying speed of the current cycle allows for a more comprehensive and intelligent determination, compared to considering only the temperature change rate, ensuring safety of the storage tank; periodically adjusting the water mist spraying speed can dynamically optimize water resource utilization efficiency, achieving efficient cooling while conserving water resources.

S240, controlling the cooling device to spray water mist toward an outer wall of the storage tank based on the emergency control parameter to cool the storage tank.

In some embodiments, the processor may control the cooling device to spray water mist toward the outer wall of the storage tank at the water mist spraying speed in the emergency control parameter.

In some embodiments, the emergency control parameter further includes the water mist spraying direction, and the emergency supervision management platform is further configured to: determine environmental wind data; determine the water mist spraying direction based on the environmental wind data; and control the cooling device to spray water mist toward the outer wall of the storage tank based on the water mist spraying direction and the water mist spraying speed.

The water mist spraying direction refers to an orientation of the water spray nozzle when the cooling device performs water mist spraying.

The environmental wind data refers to data related to wind in an area where the storage tank is located. In some embodiments, the environmental wind data includes wind speed, wind direction, or the like. The processor may determine the wind speed and the wind direction through devices such as a wind vane and an anemometer. More descriptions of the wind vane and the anemometer may be found in FIG. 2 and related descriptions thereof.

In some embodiments, since wind may interfere with water mist spraying, causing an actual spraying location of the water mist to deviate from an expected spraying location, the preset spraying direction of the water mist may be adjusted based on the environmental wind data to obtain a water mist spraying direction that can resist wind force.

In some embodiments, the processor may determine the water mist spraying direction based on the environmental wind data in various ways. For example, the processor may construct a first preset table based on reference environmental wind data, a reference initial direction, and a reference adjusted direction. The first preset table includes a corresponding relationship between the reference environmental wind data, the reference initial direction, and different reference adjusted directions. The processor may, by referring to the first preset table, determine a current adjusted direction according to current environmental wind data and an initial direction. The initial direction refers to an orientation of the water spray nozzle in a default state; the initial direction may be an orientation of the water spray nozzle when the water spray nozzle is closest to the outer wall of the storage tank; the adjusted direction refers to a corrected water mist spraying direction considering the influence of environmental wind.

In some embodiments, the processor may, in computer simulation experiments, test the deviation degree of the reference initial direction and a compensation angle required to correct the deviation when there are different reference wind speeds and reference wind directions, then correct the reference initial direction based on the compensation angle, and determine the corrected direction as the reference adjusted direction. The processor may repeat the experiment several times to obtain the first preset table.

In some embodiments, the processor may control a motor of the cooling device to rotate the water spray nozzle to the water mist spraying direction, and perform water mist spraying on the outer wall of the storage tank according to the water mist spraying direction and the water mist spraying speed. As another example, the water spray nozzle of the cooling device includes a plurality of spray heads, and the plurality of spray heads have a plurality of different spraying directions. After determining the water mist spraying direction, the processor may activate a spray head whose direction is closest to the water mist spraying direction to perform water mist spraying.

According to some embodiments of the present disclosure, determining the water mist spraying direction according to the wind direction of the environmental wind and a preset spraying direction of the water mist may reduce the influence of the environmental wind, enabling the water mist to spray onto the outer wall of the storage tank according to the preset spraying direction, thereby avoiding the environmental wind affecting the cooling effect on the outer wall of the storage tank.

Changes of the tank working state (e.g., changes of air pressure, etc.) often cause heat generation, causing temperature changes of the storage tank; at which time, the storage tank is often prone to problems; for example, if the current temperature of the storage tank has reached a dynamic balance, pressurization will cause a further temperature rise disrupting the balance, which may lead to abnormal operation of the storage tank, or even explosion. According to some embodiments of the present disclosure, by performing further data monitoring on storage tanks with state changes, safety of the storage tanks can be ensured while saving manpower and material resources.

FIG. 3 is a flowchart illustrating an exemplary process for a patrol robot to complete a patrol according to some embodiments of the present disclosure. As shown in FIG. 3, a process 300 includes the following operations. In some embodiments, the process 300 may be executed by a processor.

S310, obtaining tank operation data at a second preset time and a tank feature.

The second preset time refers to a preset historical time period; the second preset time is similar to the first preset time, and may be set by technicians based on experience.

The tank operation data refers to data related to operation of the storage tank, for example, a liquid storage output rate, a liquid storage input rate, an internal working temperature of the storage tank, an internal working air pressure or hydraulic pressure of the storage tank, etc.

The tank feature may reflect inherent properties of the storage tank, for example, a storage tank type, a storage tank capacity, etc.

In some embodiments, the processor may retrieve the operation record of the storage tank from a storage medium to determine the tank operation data at the second preset time; the processor may retrieve materials such as a factory report and an installation record of the storage tank from the storage medium to determine the tank feature.

S320, determining a patrol parameter based on the tank operation data at the second preset time and the tank feature.

The patrol parameter is a parameter for controlling the patrol robot to perform a patrol.

In some embodiments, the patrol parameter includes a patrol path and a data collection time.

The patrol path refers to a preset movement route of the patrol robot when executing a patrol task. The processor may generate the patrol path through manners such as a path generation algorithm.

The data collection time refers to a time when the patrol robot collects tank monitoring data. A longer data collection time leads to more precise information collection for the storage tank; a shorter data collection time leads to a faster patrol speed of the patrol robot.

In some embodiments, the processor may determine the patrol parameter in various ways. For example, the processor may determine the patrol path through the path generation algorithm, and determine the data collection time based on a second preset table.

In some embodiments, the processor may obtain a plurality of groups of historical operation records of the storage tank from the storage medium, and the processor may exclude historical operation records where the storage tank previously experienced abnormalities or accidents. The processor may construct the second preset table based on historical tank operation data, historical tank features, and historical data collection times in the remaining historical operation records. The second preset table includes a correspondence relationship between the tank operation data, the tank feature, and the data collection time. The processor may determine the data collection time by querying the second preset table based on the tank operation data at the second preset time and the tank feature.

In some embodiments, the patrol parameter further includes a patrol priority of the storage tank. The emergency supervision management platform is further configured to: determine a rest parameter of the storage tank; determine the patrol parameter based on the tank operation data at the second preset time, the tank feature, and the rest parameter.

The patrol priority reflects an important degree of different storage tanks.

The rest parameter reflects a duration for which the storage tank is in an unavailable state; the rest parameter may be represented as a duration for which the storage tank performs liquid storage input or liquid storage output. The processor may retrieve the operation record of the storage tank from the storage medium to determine the rest parameter.

In some embodiments, for each storage tank, the processor may further determine the data collection time of the storage tank through the second preset table. A collection time score is obtained by performing normalization processing and weighted summation on the data collection time and the rest parameter of the storage tank.

In some embodiments, the patrol priority of the storage tank is positively correlated with the collection time score. That is, a higher collection time score indicates a longer data collection time of the storage tank, more untimely data acquisition of the storage tank, and a larger rest parameter of the storage tank, indicating that the storage tank has undergone liquid storage input and liquid storage output for a long time. Compared with a storage tank with a lower collection time score (e.g., a storage tank in static storage), the storage tank is more likely to have a risk and requires a higher patrol priority.

Merely by way of example, the collection time score may be obtained based on the following formula (2):

$$M = {k}_{3} \times T + {k}_{4} \times N , \qquad ( 2 )$$

where M represents the collection time score, T represents the normalized data collection time, N represents the normalized rest parameter, k₃ and k₄ are coefficients greater than 0, and values of the coefficients k₃ and k₄ may be preset based on prior experience.

In some embodiments, if patrol priorities of a plurality of storage tanks are the same, a plurality of patrol robots may be dispatched to patrol the plurality of storage tanks simultaneously.

According to some embodiments of the present disclosure, when the patrol robot patrols according to the patrol priority, it can prioritize patrolling storage tanks with higher risks, which can make the patrol sequence of storage tanks more reasonable, improve the patrol efficiency of the patrol robot, and timely ensure the safety of the storage tanks.

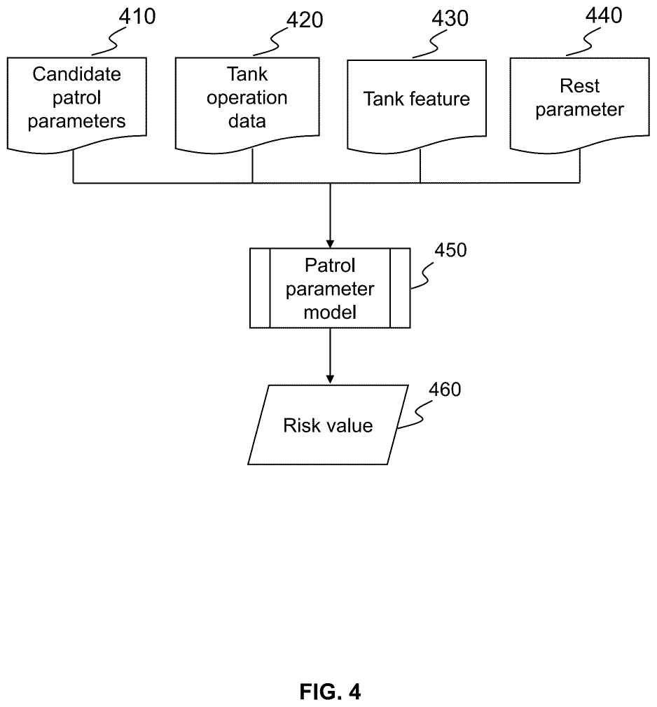

In some embodiments, the processor may determine the patrol parameter based on a patrol parameter model. More descriptions of the patrol parameter model may be found in FIG. 4 and related descriptions thereof.

S330, driving a motor of a patrol robot to move based on the patrol parameter, driving the patrol robot to perceive an obstacle in real time and adjust a patrol path through a LiDAR and an ultrasonic obstacle avoidance device of the patrol robot.

The LiDAR is a sensing device that scans an environment and measures a distance through laser beams. The ultrasonic obstacle avoidance device is a sensing device that measures a distance based on an ultrasonic echo. The LiDAR and the ultrasonic obstacle avoidance device may be used for autonomous navigation and obstacle avoidance of the patrol robot.

In some embodiments, the patrol robot detects whether an obstacle exists on the patrol path through the LiDAR and the ultrasonic obstacle avoidance device. When the patrol robot detects an obstacle, the patrol robot may adjust the patrol path to avoid the obstacle, and continue to execute a patrol task according to the adjusted patrol path.

In some embodiments, the processor may determine the patrol path based on the tank monitoring data and the patrol parameter. For example, the processor may determine a plurality of storage tanks to be patrolled and a priority sequence based on an outer wall temperature of each storage tank in the tank monitoring data and the patrol priority in the patrol parameter, and determine the patrol path through a manner such as the path generation algorithm.

S340, driving the patrol robot to collect the tank monitoring data in a patrol area to complete patrol.

The patrol area refers to a spatial range that the patrol robot needs to patrol. For example, the patrol area may be a plant area where the storage tank is located.

In some embodiments, the processor may determine a storage tank to be patrolled based on the tank monitoring data, and further determine the patrol area based on the storage tank to be patrolled.

In some embodiments, the patrol robot may collect the tank monitoring data through the data collection device of the patrol robot. The data collection device may be a camera, a temperature sensor, a humidity sensor, etc. When the patrol robot has collected the tank monitoring data of all storage tanks, the patrol is completed.

According to some embodiments of the present disclosure, determining the data collection time of the storage tank based on the tank operation data and the tank feature may reasonably arrange the data collection time of each storage tank according to different situations of each storage tank, thereby improving the patrol efficiency of the patrol robot.

FIG. 4 is a schematic diagram of a patrol parameter model according to some embodiments of the present disclosure.

In some embodiments, the emergency supervision management platform is further configured to: determine candidate patrol parameters 410; determine a risk value 460 based on at least one candidate patrol parameter 410 of the candidate patrol parameters, the tank operation data 420 at the second preset time, the tank feature 430, and the rest parameter 440 using a patrol parameter model 450, wherein the patrol parameter model 450 is a machine learning model; and determine the patrol parameter based on the risk value 460.

The candidate patrol parameter refers to a patrol parameter to be selected.

In some embodiments, the processor may obtain a plurality of historical patrol parameters from a historical patrol record, sort the historical patrol parameters according to usage frequency, and select top N historical patrol parameters as candidate patrol parameters. The preset selection quantity N may be set by a technician based on experience.

The risk value may reflect a risk degree of the storage tank. A storage tank with a larger risk value requires more timely patrol.

In some embodiments, the processor may determine the risk value based on the patrol parameter model.

The patrol parameter model is a prediction model used to determine the risk value corresponding to the patrol parameter. In some embodiments, the patrol parameter model may be a machine learning model, for example, any one or a combination of a convolutional neural network (CNN) model, or other custom model structures, etc.

In some embodiments, an input of the patrol parameter model includes the candidate patrol parameter, the tank operation data at the second preset time, the tank feature, and the rest parameter, and an output includes the risk value at the future time.

In some embodiments, the patrol parameter model may be obtained through training in various ways. For example, the patrol parameter model may be obtained by training a plurality of first training samples with first labels. Each first training sample may include a sample patrol parameter, sample tank operation data, a sample tank feature, and a sample rest parameter at a first historical time. The first label corresponding to the first training sample is a sample risk value at the second historical time, and the first historical time is earlier than the second historical time.

In some embodiments, the processor may use a historical patrol parameter, historical tank operation data, a historical tank feature, and a historical rest parameter at the first historical time obtained from the historical patrol record as the first training sample, and use a historical risk value at the second historical time as the first label. The processor may count an occurrence frequency of abnormal events in a historical patrol process corresponding to the first training sample, and the historical risk value is positively correlated with the occurrence frequency of abnormal events. The abnormal events include failure to patrol a storage tank with low safety, maintenance of the storage tank, abnormal operation of the storage tank, occurrence of a malignant accident to the storage tank, etc.

In some embodiments, the processor may input the sample candidate patrol parameter, the sample tank operation data, the sample tank feature, and the sample rest parameter into an initial patrol parameter model, construct a loss function based on the risk value output by the initial patrol parameter model and the first label, update the initial patrol parameter model based on the loss function, and when a training end condition is satisfied, the training of the initial patrol parameter model is completed and a trained patrol parameter model is obtained. The training end condition may be convergence of the loss function, a count of iterations reaching a threshold, etc.

In some embodiments, the processor may select a candidate patrol parameter with a lowest risk value as the patrol parameter.

According to some embodiments of the present disclosure, candidate patrol parameters are selected from historical patrol parameters, and then the patrol parameter model is used to further determine risk values corresponding to the candidate patrol parameters. The patrol parameter is determined based on the risk values, which can prevent some storage tanks from being left unpatrolled or patrolled untimely, thereby improving the safety of the storage tanks.

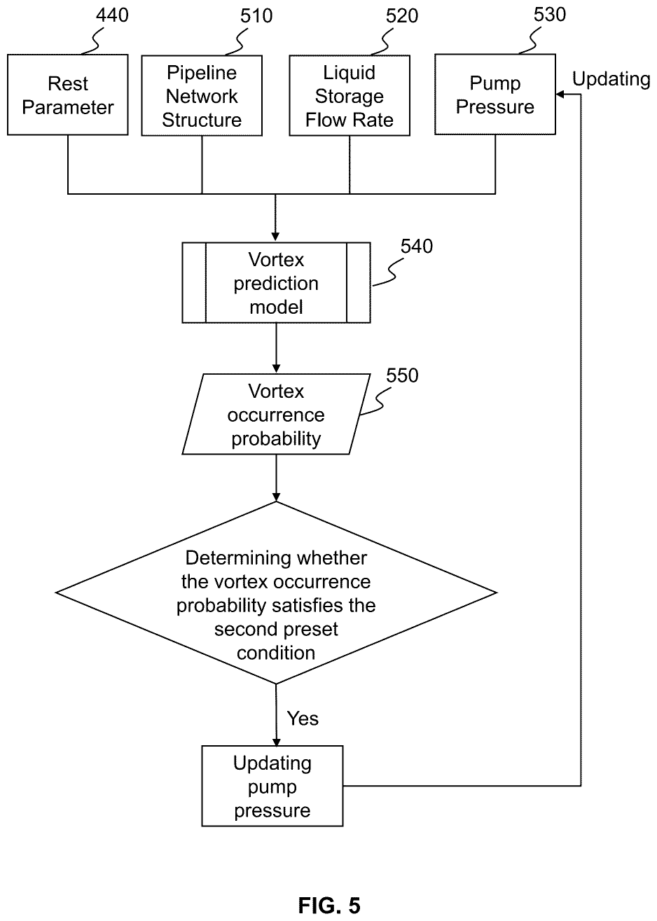

FIG. 5 is a schematic diagram illustrating an exemplary process for updating a pump pressure according to some embodiments of the present disclosure.

In some embodiments, the emergency control parameter further includes a pump pressure of a tank pipeline network. The emergency supervision management platform is further configured to: determine the vortex occurrence probability at a preset location in the tank pipeline network based on the rest parameter of the storage tank; and in response to determining that the vortex occurrence probability satisfies a second preset condition, update the pump pressure to adjust the liquid storage flow rate of the storage tank.

The tank pipeline network refers to a transportation network that connects the storage tank to other equipment, pipelines, or facilities. The pump pressure refers to the pressure applied by a pump of the tank pipeline network when transmitting the liquid storage. The greater the pump pressure, the faster the flow rate, and the higher the liquid storage transmission efficiency; the lower the pump pressure, the slower the flow rate, and the lower the probability of vortex occurrence. The liquid storage flow rate refers to the speed at which the liquid storage enters or leaves the storage tank.

In some embodiments, the processor may obtain the pump pressure based on the pressure gauge installed at the inlet and the outlet of the storage tank.

The preset location refers to a key node in the tank pipeline network. For example, the key node may include the outlet and the inlet of the storage tank, a pipeline fork, installation locations of devices such as a pump, a valve, and a flow meter, etc.

In some embodiments, the preset location may be preset based on prior experience. The processor may also determine a location pre-inputted by a technician as the preset location.

The vortex refers to a vortex that occurs when the liquid storage flows in the tank pipeline network. When the vortex occurs, the vortex causes the storage tank to generate pressure waves during liquid storage input or liquid storage output, reducing the stability of the storage tank during liquid storage input or liquid storage output.

The vortex occurrence probability refers to a magnitude of a vortex occurrence probability at the preset location.

In some embodiments, the processor may determine the vortex occurrence probability based on a vortex prediction model.

The vortex prediction model refers to a model for predicting the vortex occurrence probability. In some embodiments, the vortex prediction model may be a machine learning model, for example, any one or a combination of a regression model, a neural network (Neural Networks, NN) model, or other custom model structures, etc.

In some embodiments, an input of the vortex prediction model 540 is the pump pressure 530, a pipeline network structure 510 of the tank pipeline network, the liquid storage flow rate 520, and the rest parameter 440 of the storage tank, and an output is the vortex occurrence probability 550 of the preset location. The pipeline network structure of the tank pipeline network may reflect connection features of the tank pipeline network. The pipeline network structure may include a count of pipeline networks, connection relationships, spatial distribution, and a count of bends, etc. The processor may obtain the pipeline network structure from documents, such as laying records of the tank pipeline network. More descriptions of the pump pressure, the liquid storage flow rate, the rest parameter, and the vortex occurrence probability may be found in the above descriptions.

In some embodiments, the vortex prediction model may be obtained based on training in various ways. For example, the vortex prediction model may be obtained by training using a plurality of second training samples with second labels. The second training sample may include a sample pump pressure, a sample pipeline network structure, a sample liquid storage flow rate, and a sample rest parameter of a sample storage tank. The second label indicates whether a vortex occurs at a sample preset location of the sample storage tank. When a vortex occurs at the sample preset location, the second label is 1; otherwise, when no vortex occurs at the sample preset location, the second label is 0.

In some embodiments, the processor may obtain tank operation data, determine a historical pump pressure, a historical pipeline network structure, a historical liquid storage flow rate, and a historical rest parameter in the tank operation data as the second training sample, and determine a historical vortex occurrence probability of a historical preset location as the second label. The processor may determine the historical vortex occurrence probability through manners, such as manual annotation.

In some embodiments, since a vortex causes a fluctuation in a liquid flow rate within the pipeline network, the processor may obtain a historical liquid storage flow rate of the historical preset location. When the historical liquid storage flow rate of a certain historical preset location is significantly different from historical liquid storage flow rates of adjacent upstream and downstream historical preset locations, the processor may determine that a vortex exists at the historical preset location and determine the second label of the historical preset location as 1; otherwise, the processor may determine the second label of the historical preset location as 0.

A training manner of the vortex prediction model is similar to the training manner of the patrol parameter model, and more descriptions of the training manner of the patrol parameter model may be found in the above descriptions.

The second preset condition is a judgment condition for determining whether to adjust the pump pressure. When a vortex occurrence probability in the tank pipeline network is too high, the pump pressure needs to be updated.

In some embodiments, the second preset condition may be: vortex occurrence probabilities of any preset location is greater than a preset probability threshold. The second preset condition may also be: a count of preset locations with vortex occurrence probabilities greater than the preset probability threshold is greater than a number M. The preset probability threshold and the number M may be set by a technician based on experience.

In some embodiments, the processor may update the pump pressure based on the vortex occurrence probability. For example, a reduction magnitude of the pump pressure is positively correlated with the vortex occurrence probability. For example, the greater the vortex occurrence probability, the greater the reduction magnitude of the pump pressure.

In some embodiments, when there are a plurality of pumps in the tank pipeline network, in response to the average value of the vortex occurrence probabilities of the preset locations being greater than the preset probability threshold, the processor may reduce pump pressures of all the pumps in a batch based on the vortex occurrence probabilities at the preset locations.

In some embodiments, in response to vortex occurrence probabilities of partial preset locations being greater than the preset probability threshold, the processor may only reduce the pump pressures corresponding to the partial preset locations.

In some embodiments, the reduction magnitude of the pump pressure is positively correlated with a magnitude by which the vortex occurrence probability exceeds the preset probability threshold. The greater the magnitude by which the vortex occurrence probability exceeds the preset probability threshold, the greater the vortex occurrence probability, and the pump pressure needs to be greatly reduced to decrease the liquid storage flow rate, thereby suppressing vortex formation.

In a storage tank group connected through a complex tank pipeline network, each storage tank generates pressure waves during liquid storage input or liquid storage output. The pressure waves not only affect the pressure stability of the storage tank itself, but also propagate along pipeline network channels, impacting other storage tanks downstream and on adjacent branches. According to some embodiments of the present disclosure, by predicting vortex occurrence probabilities of different preset locations in advance, and reducing the pump pressures corresponding to preset locations with higher vortex occurrence probabilities in advance, the probability of vortex occurrence can be reduced, the stability of the liquid storage flow rate during liquid storage output or liquid storage input of the storage tank can be ensured, and the safety of the storage tank during liquid storage input or liquid storage output can be improved.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system for emergency handling of urban storage tanks based on an Internet of Things (IoT) large model, wherein the system comprises an emergency supervision management platform, and the emergency supervision management platform is configured to:
obtain a tank working state of a storage tank at a first preset time;
determine a state change value of the storage tank based on the tank working state;
in response to determining that the state change value satisfies a first preset condition,
determine an emergency control parameter based on tank monitoring data, wherein the emergency control parameter includes a water mist spraying speed of a cooling device; and
control the cooling device to spray water mist toward an outer wall of the storage tank based on the emergency control parameter.

2. The system according to claim 1, wherein the emergency supervision management platform is further configured to:
obtain tank operation data at a second preset time and a tank feature;
determine a patrol parameter based on the tank operation data at the second preset time and the tank feature, wherein the patrol parameter includes a data collection time of the storage tank; and
drive a motor of a patrol robot to move based on the patrol parameter, drive the patrol robot to perceive an obstacle in real time and adjust a patrol path through a light detection and ranging (LiDAR) and an ultrasonic obstacle avoidance device of the patrol robot, and collect the tank monitoring data in a patrol area to complete patrol.

3. The system according to claim 2, wherein the patrol parameter further includes a patrol priority of the storage tank, and the emergency supervision management platform is further configured to:
determine a rest parameter of the storage tank; and
determine the patrol parameter based on the tank operation data at the second preset time, the tank feature, and the rest parameter.

4. The system according to claim 3, wherein the emergency supervision management platform is further configured to:
determine candidate patrol parameters;
determine a risk value based on at least one candidate patrol parameter of the candidate patrol parameters, the tank operation data at the second preset time, the tank feature, and the rest parameter using a patrol parameter model, wherein the patrol parameter model is a machine learning model; and
determine the patrol parameter based on the risk value.

5. The system according to claim 1, wherein the emergency control parameter further includes a water mist spraying direction, and the emergency supervision management platform is further configured to:
determine environmental wind data;
determine the water mist spraying direction based on the environmental wind data; and
control the cooling device to spray the water mist toward the outer wall of the storage tank based on the water mist spraying direction and the water mist spraying speed.

6. The system according to claim 5, wherein the emergency supervision management platform is further configured to:
in a preset cycle:
obtain tank operation data and an environmental humidity of a previous cycle;
determine a temperature change rate based on the tank operation data of the previous cycle, and determine a humidity change rate based on the environmental humidity of the previous cycle; and
determine a water mist spraying speed of a current cycle based on the temperature change rate and the humidity change rate.

7. The system according to claim 6, wherein a cycle duration of the preset cycle is related to a patrol parameter.

8. The system according to claim 1, wherein the emergency control parameter further includes a pump pressure of a tank pipeline network, and the emergency supervision management platform is further configured to:
determine a vortex occurrence probability at a preset location in the tank pipeline network according to a rest parameter of the storage tank; and
in response to determining that the vortex occurrence probability satisfies a second preset condition, update the pump pressure to adjust a liquid storage flow rate of the storage tank.

9. A method for emergency handling of urban storage tanks based on an Internet of Things (IoT) large model, comprising:
obtaining a tank working state of a storage tank at a first preset time;
determining a state change value of the storage tank based on the tank working state;
in response to determining that the state change value satisfies a first preset condition,
determining an emergency control parameter based on tank monitoring data, wherein the emergency control parameter includes a water mist spraying speed of a cooling device; and
controlling the cooling device to spray water mist toward an outer wall of the storage tank based on the emergency control parameter to cool the storage tank.

10. The method according to claim 9, further comprising:
obtaining tank operation data at a second preset time and a tank feature;
determining a patrol parameter based on the tank operation data at the second preset time and the tank feature, wherein the patrol parameter includes a data collection time of the storage tank; and
driving a motor of a patrol robot to move based on the patrol parameter, driving patrol robot to perceive an obstacle in real time and adjust a patrol path through a light detection and ranging (LiDAR) and an ultrasonic obstacle avoidance device of the patrol robot, and collect the tank monitoring data in a patrol area to complete patrol.

11. The method according to claim 10, wherein the patrol parameter further includes a patrol priority of the storage tank, and the determining the patrol parameter based on the tank operation data at the second preset time and the tank feature includes:
determining a rest parameter of the storage tank; and
determining the patrol parameter based on the tank operation data at the second preset time, the tank feature, and the rest parameter.

12. The method according to claim 11, wherein the determining the patrol parameter based on the tank operation data at the second preset time, the tank feature, and the rest parameter includes:
determining candidate patrol parameters;
determining a risk value based on at least one candidate patrol parameter of the candidate patrol parameters, the tank operation data at the second preset time, the tank feature, and the rest parameter using a patrol parameter model, wherein the patrol parameter model is a machine learning model; and
determining the patrol parameter based on the risk value.

13. The method according to claim 9, wherein the emergency control parameter further includes a water mist spraying direction, and the controlling the cooling device to spray water mist toward an outer wall of the storage tank based on the emergency control parameter includes:
determining environmental wind data;
determining the water mist spraying direction based on the environmental wind data; and
controlling the cooling device to spray the water mist toward the outer wall of the storage tank based on the water mist spraying direction and the water mist spraying speed.

14. The method according to claim 13, further comprising:
within a preset cycle:
obtain tank operation data and an environmental humidity of a previous cycle;
determine a temperature change rate based on the tank operation data of the previous cycle, and determine a humidity change rate based on the environmental humidity of the previous cycle; and
determine a water mist spraying speed of a current cycle based on the temperature change rate and the humidity change rate.

15. The method according to claim 14, wherein a cycle duration of the preset cycle is related to a patrol parameter.

16. The method according to claim 9, wherein the emergency control parameter further includes a pump pressure of a tank pipeline network, and the method further comprises:
determining a vortex occurrence probability at a preset location in the tank pipeline network according to a rest parameter of the storage tank; and
in response to determining that the vortex occurrence probability satisfies a second preset condition, updating the pump pressure to adjust a liquid storage flow rate of the storage tank.

17. A non-transitory computer-readable storage medium, wherein the storage medium stores computer instructions, and when a computer reads the computer instructions in the storage medium, the computer executes the method according to claim 9.
